(19) United States
(12) Patent Application Publication
(10) Pub. No.: US 2025/0067656 A1
(43) Pub. Date: Feb. 27, 2025

(54) ELEMENT FOR AN OPTICAL MEASUREMENT SYSTEM

(71) Applicant: DIAGDEV, CASTRIES (FR)

(72) Inventor: Benoit, Georges, Gérard MERCHEZ, COMBAILLAUX (FR)

(73) Assignee: DIAGDEV, CASTRIES (FR)

(21) Appl. No.: 18/722,074

(22) PCT Filed: Dec. 16, 2022
(86) PCT No.: PCT/FR2022/052395

§ 371 Date: Jun. 20, 2024

(30) Foreign Application Priority Data
Dec. 20, 2021 (FR) FR2114011

(51) Int. Cl. G01N 15/1434; G01N 21/03; G01N 21/05

(52) U.S. Cl. CPC G01N 15/1436; G01N 21/0303; G01N 21/05; G01N 2015/1452

(57) ABSTRACT

An element for optical measurement system including a first crown extending circumferentially around an axis and including at least one first optical lens, and a second crown located radially outside of the first crown and surrounding the first crown and including at least one second optical lens where at least one first lens is aligned with at least one second lens, the first and second crowns are made of the same material so as to form a unitary element.

### FIELD

The invention relates to an element for an optical measurement system, intended in particular for implementing measurements with which to characterize cells, in particular biological cells, by flow cytometry.

### BACKGROUND

Flow cytometry serves to determine characteristics and properties of cells, for example their sizes, intracellular contents, DNA content, etc. It also allows the study of the variation and distribution of these characteristics within a cellular population, leading in the end to the identification of subpopulations among the cells, like for example the differentiation of the various cells making up blood.

Further, flow cytometry is a quick method. Typically, several thousands of cells are characterized per minute. It thus allows the counting and characterization of rare cellular subpopulations. The rarity of these subpopulations generally does not allow their microscopic observation and characterization, in particular because of the impossibility of obtaining a statistically acceptable number of measurements of these subpopulations.

Further, because of the improvement of optical sensors and in particular their capacity to detect lower and lower intensity signals, it is possible both to measure the volume of a cell via an impedance measurement (Coulter measurement) and also to get information on its cellular content via one or more optical measurement(s).

Flow cytometry principally consists of passing cells individually in a liquid vein of large section compared to the size of the cells. This liquid vein ends in a nozzle having a calibrated opening, sized for blocking the simultaneous passage or passage too close together in time of two or even several cells. Since the flow rate is constant between the liquid vein and the opening, and the diameter of the liquid vein decreasing, the speed of the cells increases and, on discharge from the nozzle, the cells reach flow rates of order several thousands of cells per second in a liquid jet with the diameter of the nozzle.

Measuring the volume of the cells is done by measuring the impedance on either side of the opening of the nozzle. In fact, the volume of a cell is correlated with an impedance variation produced by passage thereof in a conducting medium (Coulter system), where the cell is considered to be electrically insulating. The volume is determined absolutely, whatever the shape of the cell.

Further, the passage of the cells through the opening of the nozzle assures some hydrodynamic centering of the cells and also the orientation thereof. In that way, it is possible to precisely position the jet leaving the nozzle and containing the cells in a light beam emitted by an excitation source. When a cell passes through the light beam, it diffuses some number of optical signals which can be used by the cytometer in order to determine the properties of the cell.

These optical signals comprise:
reflection of the light from the cell, due to different indices between the liquid and the cell, but also between different cellular components, seen by the reflection of a portion of the incident light beam;
refraction of the light by the cell seen as a deviation of the light ray entering the cell; and
diffraction of the light by the cell, principally through a solid angle ranging from a few degrees through a solid angle of 360°.

All these signals are gathered by an optical collection system, and then separated by their wavelength (width at half-height included between 20 and 50 nm, even 30 to 40 nm) by an optical filter system and finally arrive at various light sensors.

These various sensors may be suited for:
measuring small angle diffusion (forward scattering) from the cell;
measuring large angle diffusion (back scattering) from the cell;
measuring the absorbance of the cell; and
measuring the fluorescence of the cell if it is marked by one or more fluorochromes.

Forward scattering is due to diffusion by the cell membrane of part of the incident light arriving on the surface of the membrane. The portion of the light that is diffused has the same wavelength as the incident light. It is captured in the axis of the incident light. It gives information about the size and average index of refraction of the cell.

Backscattering is due to diffusion in all spatial angles by intracellular organelles of the portion of incident light which passes through the cell membrane. It may be captured by a photomultiplier or avalanche photodiode. Since backscattering involves the properties of refraction and reflection, it provides information on the fine heterogeneity of the cellular contents.

Measuring the absorbance and/or extinction is for its part done in the excitation beam axis of the cell. The measurement is proportional to the diameter of the cell and to the index of absorption of the intracellular organelles.

In the case where the cell is marked by one or more fluorochromes, when excited they emit fluorescence isotropically, meaning in all spatial directions, at one or more wavelengths longer than that of the excitation source. Interference filters allow the separation of various fluorescence wavelengths (generally in spectra with width at half-height from 20 to 50 nm, even 30 to 40 nm), each sent on a photomultiplier. The intensity of the measured fluorescence depends on the number of fluorochrome molecules fixed on the cell. For example, in the case of using the DRACQ 5 marker, which is a fluorochrome passing through the cellular cytoplasmic membrane passively and specifically binding to DNA, it is possible to extract information about nucleated cells. The DRACQ 5 marker has two absorption maxima at 622 nm and 676 nm and two others in the ultraviolet range at 240 nm and 314 nm. It emits fluorescence in the red with wavelengths included between 665 nm and 800 nm. The filter generally used is a dichroic type filter which reflects at 90° from the incident beam all spectral components shorter than 650 nm and transmits the spectral components longer than 650 nm. Considering the definition of the light source, the first filter is naturally centered at the wavelength of the light source with a passband of order 50 nm.

Thus, in this arrangement, it is possible for each particle to measure three physical magnitudes: an electrical measurement representative of the particle's volume, an extinction measurement linked to the refringence of the cell, and finally a fluorescence measurement linked to the nucleic acid content of the analyzed cell.

Flow cytometry is advantageously used for the study of the hematology allowing a diagnosis and therapeutic monitoring of various viruses, infections and parasites, and also the functional study of healthy cells. Flow cytometry makes it possible to count and characterize the various blood cell types. For example, by using flow cytometry with leukocytes, the total number thereof can be counted, and they can be distinguished according to their morphology and classified in three different types by using an impedance measurement of the cell volume and an absorption measurement.

The first type is the monocytes which are large-size cells (20 to 40 μm diameter). The shape of the nucleus may be rounded, oval, kidney or distinctly irregular; the most common case is kidney-shaped. The chromatin is not dense, not clumpy and has a uniform structure. The residence time of monocytes in the blood is two days before their tissue passage and the bone marrow transit time is 1 to 2 days. When they are activated, they become macrophages.

They are capable of phagocytizing bacteria, whole cells and also various particles called pollutants, like dust, for example.

The phagocytes are a second type that has a major role in the immune system. They can be separated into two groups of different sizes:
small size lymphocytes (7 to 9 μm diameter) which have a rounded or oval shape nucleus, sometimes kidney-shaped with a slightly extended cytoplasm, clear or slightly basophil and most often extending from only one side of the nucleus; and
larger size lymphocytes (9 to 15 μm diameter) which have a centered or slightly off-center nucleus with a more extended cytoplasm than that of the small size lymphocytes and completely surrounding the nucleus.

A third type, granulocytes or also called polynuclear, and whose main function is protection against infections, may be separated into three subcategories. First, the neutrophils are the most abundant granulocytes (about 96%). There are rounded and have a 12 to 14 μm diameter. They are characterized by the multilobular shape of their nucleus (from 3 to 5 lobes). They have a residence time in the blood of two days before their tissue passage and the bone marrow transit time of the granular precursors is 10 to 14 days. There is a bone marrow reserve compartment for neutrophils. There are very effective in the destruction of bacteria and predominant during acute inflammation. Their essential role is defense of the organism against foreign microorganisms, such as bacteria and yeast. Their excretory functions support local inflammatory reactions of tissues and contribute to the defense thereof. Next, the basophils have very low abundance and represent only about 0.5% of the leukocytes. They have a diameter of 10 to 14 μm. Their bilobed nucleus is masked by specific granulations which are fairly numerous and dispersed throughout the cell. Their residence time in the blood is 12 to 24 hours, without known tissue passage. The transit time in the marrow is identical to that of the neutrophils. An important function of the basophils is to attract the eosinophils. Finally, the eosinophils represent about 2 to 5% of the circulating leukocytes (about 350 per cubic millimeter). These are cells of 12 to 14 μm diameter characterized by a bilobed nucleus and especially by the appearance of the granulations which are spherical (0.5 to 1.5 μm diameter). They contain azurophilic granules. Polynuclear eosinophils are key cells in allergic inflammation and antiparasitic defense. Their distribution is especially in tissue; the circulating fraction representing only 1% of the total number of eosinophils. Their transit time in the blood is from 3 to 8 hours after leaving the marrow and until their deposit in the tissue (in particular intestines, lungs, skin and uterus) where they will have a lifespan of some 10 days. Another example, it is possible to determine the total number of erythrocytes and platelets, to distinguish them by their morphology and to classify them by means of a cellular volume measurement by impedance and an absorption measurement.

Other applications of flow cytometry have an obvious diagnostic interest in the characterization and/or counting of various types of blood cells such as reticulocytes, erythroblasts, immature and precursor cells of leukocytes, active lymphocytes or even reticulated platelets.

Measuring the volume of the cell by impedance uses a device comprising a flow cell whose base, which has an opening with a diameter of about 50 μm, allows the individual passage of one cell in a liquid flow. Upstream from the opening, the liquid flow is formed in a sample jet comprising cells to be characterized and a sheath fluid (generally saline) surrounding the sample jet allowing hydrodynamic focusing of the sample jet. The terminals of a voltmeter are electrically connected to electrodes, one of which is placed upstream from the opening and the other downstream, O-ring joints are needed in these areas to assure the seal. The voltage variation observed when a cell passes is representative of its volume.

The bottom of the flow cell is generally made from a disk several millimeters in diameter and several microns thick made of very costly gemstones like synthetic rubies. The passage opening is machined in this disk and then the disk is manually crimped on the end of a nozzle. The crimping operation is not without risks because microfissures may appear thus creating a change in the resistivity between the positive and negative electrodes in that way corrupting the impedance measurement.

As for the optical measurements, they use another device comprising a flow cell formed of a base plate having at its center the passage opening whose 80 μm diameter allows the individual passage of one cell in a liquid flow and a transparent enclosure flattened against the base. A joint between the enclosure and the base provides the seal between these two parts. The second screening inlet by the lower part of the enclosure right by the base allows the arrival of a sheath fluid for sheathing the sample flow in order to accompany it over a length of 400 μm where the sample flow crosses a light beam emitted by the excitation source. A second joint is necessary in order to provide the seal on the upper part of the flow cell.

In order to perform the volume measurement and the optical measurements at the same time, it is possible to combine the two devices in a single device by using the base of the volume measurement device as base for the optical measurement device.

However, such an arrangement requires the use of four joints. Just the same, there is no guarantee that there will be no leaks between the various elements.

Further, such a measurement device needs a long set up time and adjustment time. In fact, it is often necessary to mount several optical subassemblies made up of one or more lenses in order to shape the so-called excitation beam and also the one or more receiving beams. Further, their alignment on the sample flow containing the cells is most often complex and generally uses a micrometric stage and/or glass slides.

Further, most of these devices only use two parameters simultaneously, specifically the volume measurement by impedance and the absorbance as optical measurement. The diagnosis of some pathologies requires finer and finer counting and characterization of hematopoietic cells in the circulating blood, thus calling for multiplication of the number of parameters, most often optical, making both mounting and adjustment more complex.

Further, still considering the need to diagnose certain very specific pathologies, in particular by discriminating the cells' RNA and DNA, most of these devices use several different markers and, consequently, many excitation wavelengths. Together these optical combinations generally call for very complex systems, which are therefore very costly.

In order to remedy at least a part of these disadvantages, the document WO 2019/002787 A1 proposes a measurement flow cell for counting and/or characterizing cells, comprising a base and a transparent lateral enclosure extending from the base in order to form an optical measurement chamber with the base, where the base has a 30 to 100 μm diameter opening for the passage of cells, and the base and transparent lateral enclosure form a single unit flow cell suited for both an impedance measurement and an optical measurement.

Because of this single-unit measurement flow cell, it is possible to do without three of the four joints previously necessary for one measurement flow cell allowing both cell volume measurements and optical measurements. In fact, because it is a single unit, the measurement flow cell no longer needs joints between the passage opening and the optical measurement chamber and also between the positive electrode and the part providing evacuation of the various liquids (sheath fluid, lysis, etc.). Further, this measurement flow cell allows a volume measurement by impedance and optical measurements on the same cell at a few microsecond intervals.

This measurement flow cell further comprises lenses and is used in a measurement system comprising a support on which said flow cell is mounted along with an optical source and optical sensors. Receiving optics comprising lenses are inserted between the flow cell and the sensors; these receiving optics need to be mounted and adjusted with precision which is a long and complex step to perform.

The invention aims to remedy this disadvantage, simply, reliably and at low cost.

### SUMMARY

For this purpose, the invention relates to an element for optical measurement system comprising a first crown extending circumferentially around an axis and comprising at least one first optical lens, and a second crown located radially outside of the first crown and surrounding the first crown and comprising at least one second optical lens where at least one first lens is aligned with at least one second lens, the first and second crowns are made of the same material so as to form a unitary element, said element comprising centering and alignment means located near at least one second lens and intended to engage with additional centering or alignment means of an optical emitter or receiver, and said element further comprising a calibrated passage opening, intended for the passage of a flow comprising a sample to be analyzed, located and oriented along said axis of the first and second crowns and opening out in a space delimited by the first crown and forming a measurement chamber through which said fluid is intended to pass.

The terms axial, radial and circumferential are defined relative to the aforementioned axis of said crowns.

In this way, said element incorporates at least one pair of lenses laid out so as to be aligned for allowing an optical measurement, without it being necessary to adjust the position of the second lens relative to the first lens. The term crown is used for indicating that, in the case where several lenses are used, they are distributed on the circumference. It is understood that the crown may be continuous or discontinuous, extending over the full circumference, meaning over 360°, or over only a part of the circumference.

The number of lenses on each crown may be at least equal to 2, for example equal to 4 or 8.

Said element may be made of a transparent material. Said element may be made of a synthetic material.

Said element may have an index of refraction included between 1.4 and 1.6. Further, said material may be selected so as to have a transmission over 90% of the operating wavelength, preferably low birefringence and low heat distortion.

The material of the unitary flow cell may principally comprise a polycycloolefin resin, in particular over 95% by weight of this resin, or even over 99.5% by weight of this resin. Zeonex T62R from Zeon® is an example of such a resin. Such a resin is very liquid in molten form and thus can be injected at very high pressure with very little shrinkage which allows precisely controlling the dimensions of the unitary flow cell and provides an optical quality surface roughness. Advantageously, the choice of such a resin guarantees a stability against yellowing over time as compared to Zeonex E48R.

Said element may be made of a material having a low resistance to water absorption, for example below 0.01%. This material may have a low dielectric constant, for example at most 3 F/m, at frequencies below 3 MHz or even below 1 MHz, so as to guarantee a good electrical insulation between two electrodes located on either side of the passage opening and intended for an impedance or resistivity measurement.

Said element may be made of a material of a type principally comprising a polycycloolefin resin, in particular over 95% by weight of this resin, or even over 99.5% by weight of this resin.

Said calibrated opening may be cylindrical with a circular base and may have a diameter included between 30 and 100 μm.

Such an opening may be obtained by laser drilling.

Said calibrated opening may be provided in a thin wall of the same material as said first and second crowns, said thin wall having a thickness included between 10 and 80 μm.

This thickness may be included between 20 and 50 μm, for example of order 30 μm.

Such a thin wall may be obtained by laser machining of a preform made by injection molding, for example.

The measurement chamber may have a polygonal shape, for example hexagonal or octagonal.

At least one first lens may be aspheric type.

Said first lens may comprise a flat radially inner surface, turned towards the measurement chamber. Said first lens may comprise a convex shape radially outer surface, turned to the side of the second crown. Said radially outer surface of the first lens may be a surface defined by the formula:

Aspheric lenses allow optical designers to correct aberrations by using fewer elements than with conventional spherical optics because they provide a greater correction of aberration compared to the use of several spherical optical surfaces. An aspheric lens, also called aspherical lens, is optics with symmetry of revolution, where the radius of curvature varies radially from the center thereof. It improves the image quality, reduces the number of elements needed, and reduces the design costs.

Aspheric lenses were traditionally defined with a surface profile given by the following equation:

$$Z ( s ) = \frac{{Cs}^{2}}{1 + \sqrt{1 - ( 1 + k ) {C}^{2} {s}^{2}}} + {A}_{4} {s}^{4} + {A}_{6} {s}^{6} + {A}_{8} {s}^{8} + …$$

Where:
Z is the sag relative to the sagittal plane of the surface parallel to the optical axis
s is the radial distance from the optical axis
C is the curvature, meaning the inverse of the radius
k is the conic constant
A4, A6, A8, . . . are respectively the fourth, sixth and eighth order aspheric terms

Each first lens may be aspheric type.

At least one second lens may be spheric type.

Said spheric lens may comprise a flat radially inner surface, turned towards the first crown. Said spheric lens may comprise a radially outer surface with a spheric portion shape, turned away from the first crown. The radius of said spheric portion is for example included between 3 and 20 mm.

Each second lens may be spheric type.

Said centering and positioning means may comprise two flat surfaces forming a V between them. The additional centering and positioning means may comprise a cylindrical portion intended to come to bear linearly on each of said flat surfaces.

Said element may comprise means for blocking rotation around the axis of the first and second crowns, intended to engage with complementary means for locking a base. The blocking means may comprise a projecting part, for example a pin or rib, intended to be inserted in a complementary shaped recess of the base, or inversely.

The element may comprise an upstream chamber, located across from the measurement chamber relative to the thin wall.

Said upstream chamber may have a conical or frustoconical shaped zone. Said conical or frustoconical shaped zone may comprise an enlarged end and a shrunken end opposite the enlarged end and formed by the thin wall comprising the calibrated opening.

The wall of the conical or frustoconical zone may form an angle included between 1° and 30° relative to the longitudinal axis of said upstream chamber.

The shrunken end may have a diameter included between 1 and 3 mm, for example of order 2 mm.

The invention also relates to a measurement system comprising an element of the aforementioned type, at least one optical emitter and at least one optical receiver, mounted facing a second lens.

The emitter may be a light-emitting diode (LED) or incandescent lamp type incoherent source.

The optical receiver may be a photodiode, an avalanche photodiode or a photomultiplier.

The system may comprise means for bringing a fluid containing a sample to be characterized into the upstream chamber, where said fluid passes through the calibrated opening and opens into the measurement chamber.

The sample may be a biological sample, for example a blood sample.

The means for bringing the fluid containing the sample may comprise a channel opening into the upstream chamber, for example in the axially median zone of said upstream chamber. Said channel may extend into a part of the upstream chamber.

The means for bringing the fluid containing the sample are designed for delivering a fluid flow rate included between 1 and 6 μL/s.

The system may comprise means for bringing a first sheath fluid near the upstream chamber.

Said upstream chamber may extend along the axis of the first and second crowns.

The means for bringing the first sheath fluid may comprise a channel opening out near the upstream end of the chamber opposite the thin wall. The opening of said channel may be offset relative to said axis.

The means for bringing the first sheath fluid are designed for delivering a fluid flow rate included between 1 and 20 μL/s.

The system may comprise means for bringing a second sheath fluid near the measurement chamber.

Said means for bringing the second sheath fluid may open out near the thin wall, for example at a distance included between 0.1 and 0.5 mm from the thin wall. Said means for bringing the second sheath fluid may open out along a direction perpendicular to the axis of the first and second crowns, meaning perpendicular to the axis of the calibrated opening in the thin wall.

The means for bringing the second sheath fluid are designed for delivering a fluid flow rate included between 30 and 80 μL/s.

The sheath fluid serves to channel the fluid flow containing the samples so as to orient and position the cells contained in the fluid flow along the axis.

The system may comprise an interference filter facing at least one second lens, mounted on said element, radially between the first and second crowns.

The system may comprise an achromatic doublet mounted on the element and arranged facing an optical emitter and a lens of the first crown. An achromatic doublet is dedicated to shaping the optical beam.

An achromatic doublet corrects chromatic aberrations and comprises a lens formed of two glasses. The achromatic doublet is not formed as a single unit with the second crown. In such a case, the second crown may comprise an opening, where the achromatic doublet is mounted in said opening or facing said opening, and may be aligned with the corresponding first lens.

The system may comprise at least two electrodes, located axially on either side of the calibrated opening, and measurement means suited for measuring an impedance between said electrodes.

Such an impedance measurement may in particular be used for counting the number of cells passing through said calibrated opening, per unit time.

The two electrodes may be axially separated from each other by a distance included between 5 and 10 mm.

### BRIEF DESCRIPTION OF THE DRAWINGS

FIG. 1 is a perspective view, from above, of an element for an optical measurement system, according to an embodiment;

FIG. 2 is a perspective view, from below, of the element from FIG. 1;

FIG. 3 is a top view of a part of a measurement system;

FIG. 4 is a section and perspective view of said part of the measurement system;

FIG. 5 is a section and perspective view of a part of the measurement system;

FIG. 6 is a perspective view of a part of a measurement system;

FIG. 7 is a section and perspective view of a part of the measurement system;

FIG. 8 is a perspective view, from above, of an element for a measurement system, according to another embodiment;

FIG. 9 is a section and perspective view of the element from FIG. 8;

FIG. 10 is a top view of a part of a measurement system equipped with the element from FIGS. 8 and 9.

### DETAILED DESCRIPTION

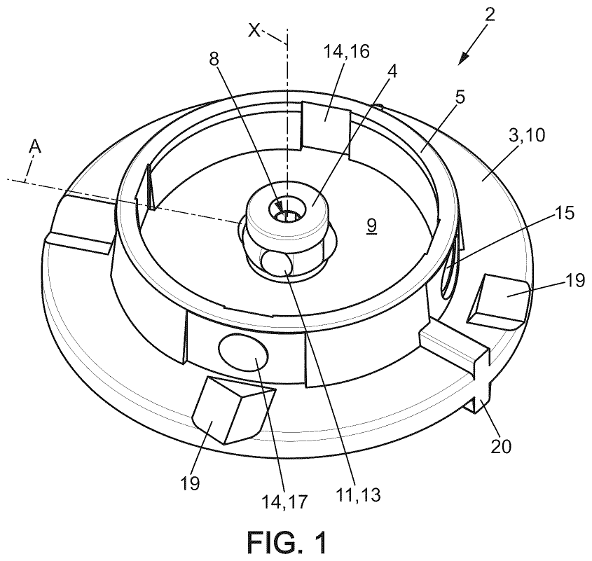

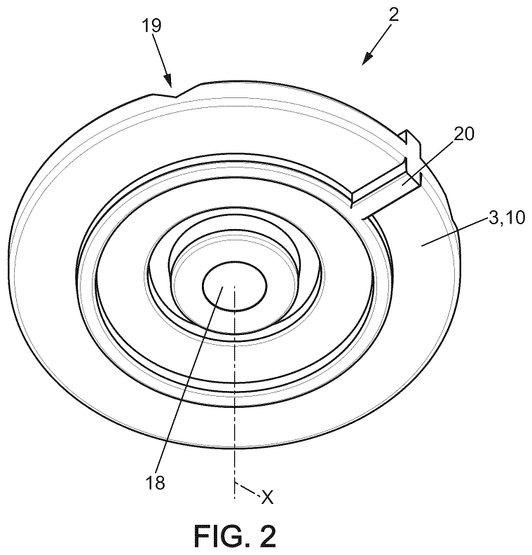

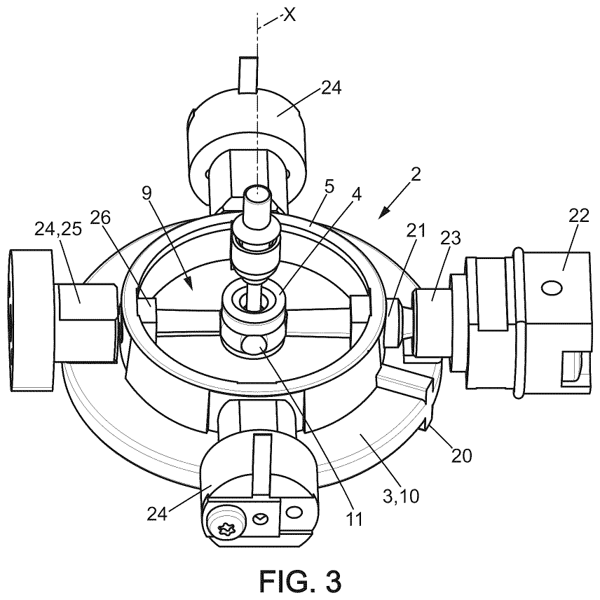

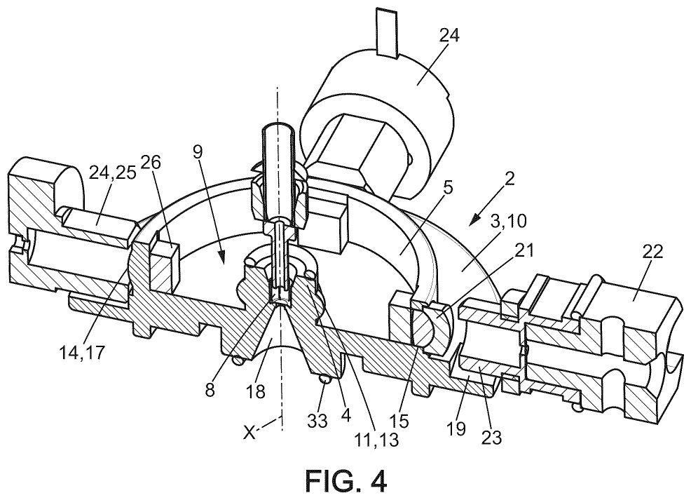

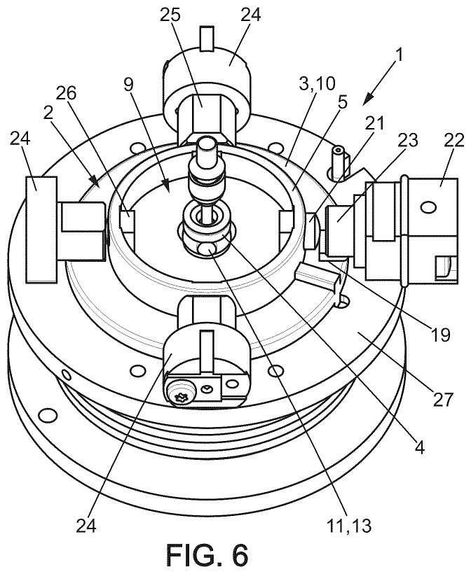

A measurement system 1 according to an embodiment is now going to be described with reference to FIGS. 1 to 7. This comprises a unitary element 2 extending around an axis X. Said element 2 comprises a disk-shaped base 3 from which extend a radially inner crown 4 and a second radially outer crown 5.

The center of the base 3 comprises a low thickness zone, called thin wall 6, provided with a calibrated opening 7.

The thin wall 6 comprises a thickness included between 10 and 80 μm, for example of order 30 μm, and the diameter of the opening 7 is included between 30 and 100 μm.

The space delimited by the central zone of the base and the first crown forms a polygonal-shaped measurement chamber 8, for example hexagonal. The edge of the hexagon forming the base of the lateral surface of the measurement chamber 8 is preferably selected between 1 and 5 mm, preferably about 2 mm. Other shapes for the base of the measurement chamber 8 may be selected, such as circular, triangular, etc. Preferably, the shape of the base of the measurement chamber 8 is a regular geometric shape, i.e. having at least one element of symmetry, preferably a center of symmetry or an axis of symmetry, such as the axis X.

The annular space located between the first crown 4 and the second crown 5 will be designated by the reference 9. The area of the base located radially outside of the second crown 5 bears the reference 10.

The first crown 4 here comprises four lenses 11, called first lenses, made as a single unit with the rest of the element 2. Each first lens 11 is an aspheric lens and comprises a flat, radially inner surface 12 turned towards the measurement chamber. Each first lens 11 further comprises a convex shape, aspheric radially outer surface 13 turned from the side of the second crown 5. The center of the corresponding asphericity is located at the outlet and near the calibrated opening 7.

The focal point of each first lens 11 is the center of the measurement flow cell. The interest of the aspheric lens resides in an improvement of the optical performance in the periphery of the image which thus guarantees a near zero spherical aberration at the focal point. Such a structure significantly reduces the spherical aberration of the measurement system 1 guaranteeing a maximum power at the measurement point. Further, a numerical opening of order 0.5 may be obtained without using objectives, unlike the devices on the market.

Additionally, the disposition of the focal point of the first lenses 11 at the outlet and near the calibrated opening 7 allows optical measurement on the cell from the sample to be analyzed as it just leaves this opening 7 and where the centering of the sample flow is the best. In fact, going farther from the outlet of the calibrated opening 7, the position of the cell is more uncertain and the risk that it is off-center relative to the sample jet is greater.

The center of the outer aspherical surface of each first lens 11 is preferably located between 200 and 600 μm, even 300 and 500 μm, even 350 and 450 μm, preferably about 400 μm, from the outlet of the calibrated opening 7 in the direction of the sample flow, meaning along the axis X.

The second crown 5 may comprise up to seven lenses 14, called second lenses, each aligned with a first lens 11 along an optical axis A extending radially relative to the axis X. The second crown 5 further comprises an opening 15 whose function will be described in the following. Each second lens 14 is spherical and comprises a flat radially inner surface 16, turned towards the first crown 4 and a radially outer surface 17 shaped as a spheric portion, turned away from the first crown 4. The radius of said spheric portion is for example included between 3 and 20 mm.

The base 3 further defines an upstream chamber 18, located across from the measurement chamber 8 relative to the thin wall 6. Said upstream chamber 18 has a conical or frustoconical shaped zone comprising an enlarged end and a shrunken end opposite the enlarged end and formed by the thin wall 6 comprising the calibrated opening 7.

The wall of the conical or frustoconical zone may form an angle included between 1° and 30° relative to the longitudinal axis X. The shrunken end may have a diameter included between 1 and 3 mm, for example of order 2 mm.

The outer peripheral zone 10 of the base 3 further comprises means of centering or positioning facing each second lens 14 and the opening 15 of the second crown 5. Said centering and positioning means comprise a recess 19 formed by two flat surfaces forming a V between them, where such a recess 19 is arranged on the upper surface of the base 3.

The base 3 further comprises means for blocking rotation around the axis X, where these means of blocking rotation comprise at least one rib 20 extending from the lower surface of the base 3.

The base 3, the crowns 4, 5 and the lenses 11, 14 are a single piece of the same material. This element 2 may be implemented by injection molding, and the thin wall 6 and the opening 7 may be obtained by laser machining and drilling.

Said element 2 is for example made of a transparent synthetic material having a low resistance to absorption of water, for example below 0.01% and having a low dielectric constant, for example at most 3 F/m, at frequencies below 3 MHZ, even below 1 MHz. Said element 2 may be made of a material of type principally comprising a polycycloolefin resin, in particular over 95% by weight of this resin, or even over 99.5% by weight of this resin. Zeonex T62R from Zeon® is an example of such a resin.

Said element 2 may have an index of refraction included between 1.4 and 1.6. Further, said material may be selected so as to have a transmission over 90% of the operating wavelength, preferably low birefringence and low heat distortion.

An achromatic doublet 21 is mounted near the opening 15 of the second crown 5, facing or at least partially in said opening 15, on the optical axis passing through the corresponding first lens 11 and said opening 15. The achromatic doublet 21 comprises a lens formed of two glasses. The achromatic doublet 21 is not formed as a single unit with the second crown 5.

An element 22 for shaping a light beam coming from at least one light source is mounted facing the achromatic doublet 21 on the corresponding optical axis. The light source or emitter is for example a light-emitting diode (LED) type light source. The element 22 comprises a body comprising a cylindrical zone 23 coming to bear linearly on each of the flat surfaces of the V-shaped recess 19, so as to assure the correct positioning of the emitter on the optical axis. This shaping element 22 comprises, for example, a window through which a light beam passes and which acts as a diaphragm, for example of rectangular shape.

Optical receivers 24, for example intended to measure absorbance, diffusion, diffraction and/or fluorescence, are mounted on the optical axes passing through the other second lenses 14. Each optical receiver 24 comprises a zone 25 coming to bear on each of the flat surfaces of the V-shaped recess 9, so as to assure the correct positioning of the receiver 24 on the corresponding optical axis.

An interference filter 26 is also mounted facing each second lens 14 and possibly the achromatic doublet 21, radially inside the second crown 5.

The flat inner surface 16 of each of the second lenses 14 allows in particular receiving a square-shaped interference filter 26, whose wavelength range will be judiciously selected. With the flat surface 16 each of the filters 26 can in particular be oriented angularly in order to guarantee their proper operation. In fact, the orthogonality of each of the light beams with the parallel surface of each of the interference filters 26 must be respected. Conventionally, the lights for fluorescence and diffraction are separated on the basis of their spectral properties. To do that, optical interference filters of multi-dielectric type are generally used; such filters result from the alternating deposit of two or more transparent materials having distinct indices of refraction. These are advantageously ion bombardment filters, which gives them very good out of spectral band blockage and very good transmission. These filters 26 are installed on the light path between the measurement chamber 8 and each second lens 14 in the areas where the light rays leaving the interaction between the light and the cells in the sample are collimated. Various filters may be used depending on the expected fluorescence wavelengths and the illumination wavelengths used.

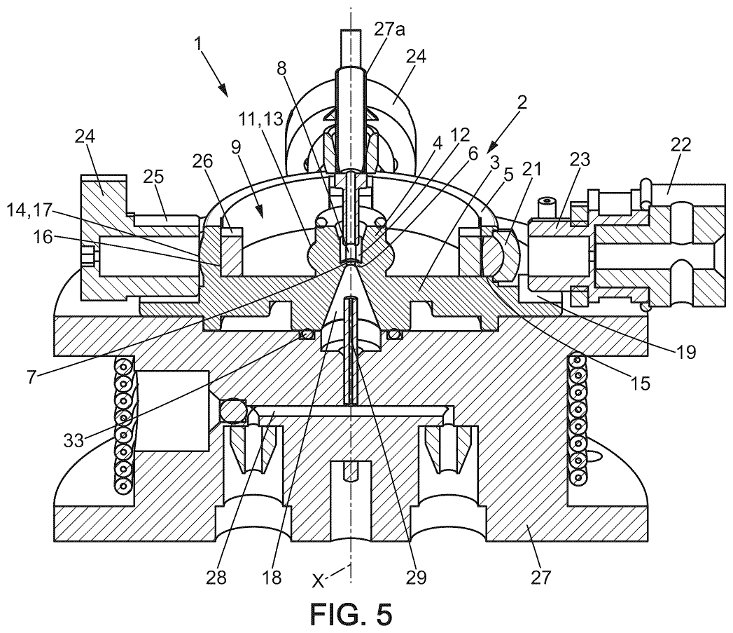

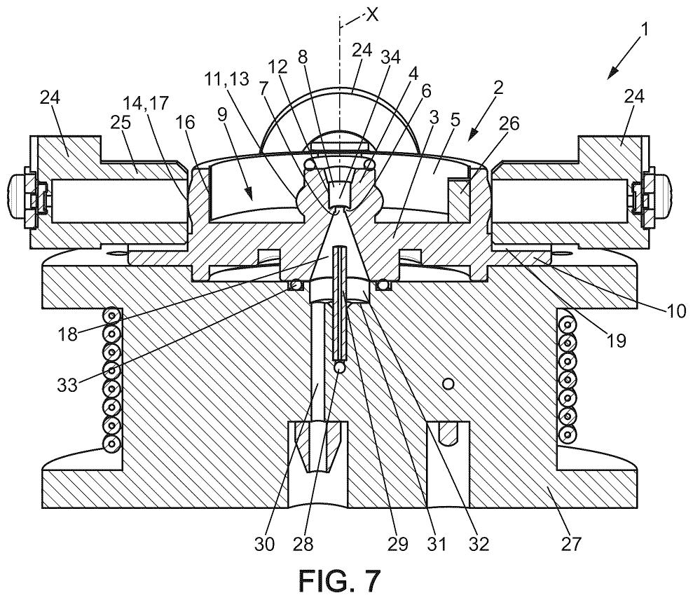

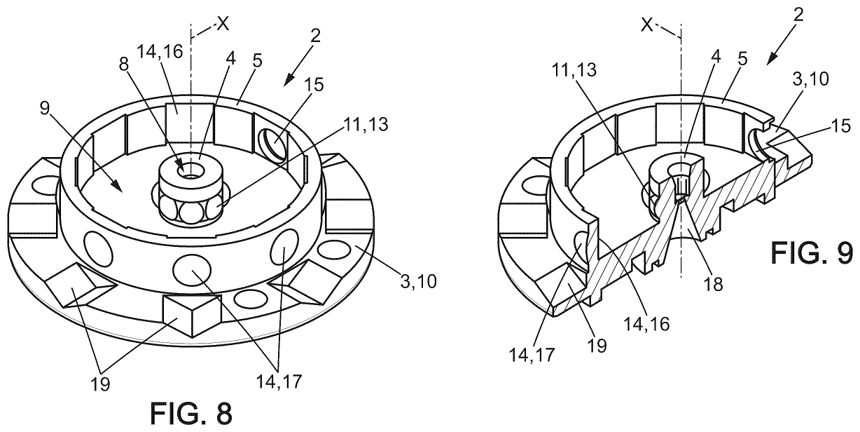

As shown in FIGS. 5 to 7, the system 1 further comprises a base 27 on which the element 2 is mounted. The base 27 comprises channels for bringing 28 a fluid containing a sample to be analyzed, for example a biological sample such as blood. The channels 28 open out into the upstream chamber 18 via a base 29 extending along the axis X. Further, as can be seen in the section from FIG. 7, the base 27 also comprises a channel 30 for bringing a first sheath fluid (FIG. 7) opening out near a bottom wall 31 of a cylindrical chamber 32 of the base 27, where said cylindrical chamber 32 extends along the axis X and opens out into the upstream chamber 18 of the element 2 near its expanded end. More specifically, the first sheath fluid opens out on radially outer periphery of the cylindrical chamber 32. An O-ring joint 33 provides the seal between the cylindrical chamber 32 of the base 27 and the upstream chamber 18 of the element 2.

Further, a second sheath fluid opens out in the measurement chamber 8, through a channel 34 (FIG. 7) arranged in the element 2, where said channel 34 opens out in a direction perpendicular to the axis X.

The rib 20 of the element 2 is engaged in a complementary shaped groove of the base 27, so as to assure the positioning and the rotational immobilization of the element 2 relative to the base 27.

The system comprises at least one first electrode 27a, for example of platinum; a second electrode may be formed by the base 27 which is, for example, steel.

These electrodes 27, 27a are located axially on either side of the calibrated opening 7 and the thin wall 6.

The system also comprises measurement means suited for measuring an impedance between said electrodes.

The two electrodes may be axially separated from each other by a distance included between 5 and 10 mm.

In operation, the fluid comprising the sample to be analyzed is brought into the upstream chamber 18 by the channel 28 and the corresponding nozzle 29; this fluid flows along the axis X and discharges into the measurement chamber 8 through the calibrated opening 7. In parallel, a first sheath fluid flow opens into the cylindrical chamber 32, through the channel 30, and then keeps the fluid containing the sample along the axis X, in the upstream chamber 18 of the element 2. This first sheath fluid thus assures the hydrodynamic centering of the jet of fluid containing the sample. Such a phenomenon is known under the term hydro-focusing and allows channeling the fluid flow containing the samples so as to orient and position the cells contained in the fluid flow along the axis.

Further, the second sheath fluid is brought in leaving the calibrated opening 7 near the discharge from the channel 34. This second sheathing fluid serves to block the recirculation volume formation by sweeping the zone, preventing a cell from leaving the fluid flow containing the sample upstream from the calibrated opening 7 and away from this opening 7, so that the optical measurements to be done will be easier.

The flow rate of fluid containing the sample is for example included between 1 and 6 μL/s.

The flow rate of the first sheath fluid is included between 1 and 20 μL/s. The flow rate of the second sheath fluid is included between 30 and 80 μL/s.

Further, optical measurements are done using optical receivers 24.

As previously indicated, the unitary implementation of the element 2 serves to lower the total cost of the measurement system 1 by freeing the user from having to place convergent lenses between on the one hand the measurement chamber 8 and on the other hand the excitation source or light source, and the receivers 24 or sensors, and from having to perform any adjustments. Further, such an element 2 allows performing measurements over 360°, all around the crowns 4, 5 bearing the lenses 11, 14.

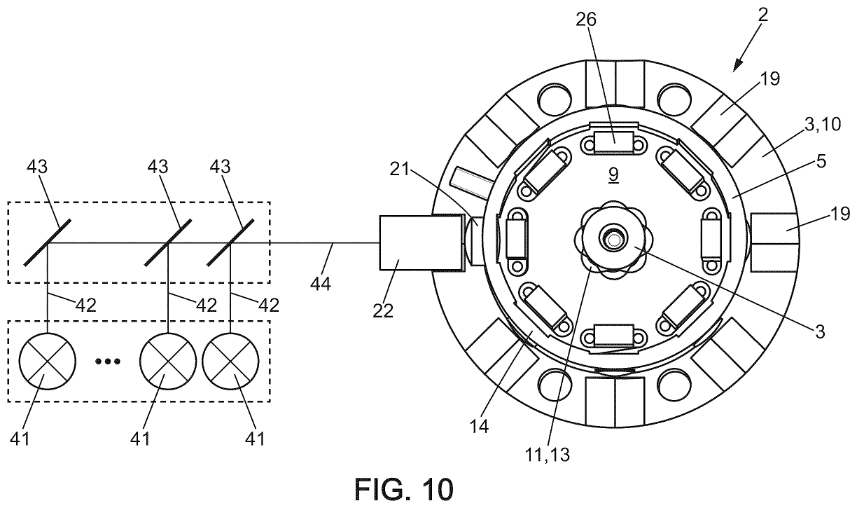

FIG. 10 shows another embodiment in which the element 2 comprises eight first lenses 11 on the first crown 4 and seven first lenses 11 and an achromatic doublet 21 on the second crown 5.

The assembly also comprises several distinct light sources 41, able to each emit a light flow 42 directed on a dichroic mirror 43 acting as a filter capable of directing a light flow of a specific light spectrum into an optical fiber 44 connected to the shaping element 22.

The use of an optical fiber serves to homogenize the light flow and separate the light sources from the element 2 in order to avoid thermal damage to the element 2 or to the sample from the heat emitted by the light sources 41.

It will be noted that the filters 26 may be adapted to the wavelengths coming from the interaction between the light beam and the sample, for example the blood cells.

1-13. (canceled)

14. An element for optical measurement system comprising a first crown extending circumferentially around an axis and comprising at least one first optical lens, and a second crown located radially outside of the first crown and surrounding the first crown and comprising at least one second optical lens where at least one first lens is aligned with at least one second lens, the first and second crowns are made of the same material so as to form a unitary element, said element comprising centering or alignment means located near at least one second lens and intended to engage with additional centering or alignment means of an optical emitter or receiver, and said element further comprising a calibrated passage opening, intended for the passage of a flow comprising a sample to be analyzed, located and oriented along said axis of the first and second crowns and opening out in a space delimited by the first crown and forming a measurement chamber through which said fluid is intended to pass.

15. The element according to claim 14, characterized in that said calibrated opening is cylindrical with a circular base and has a diameter included between 30 and 100 μm.

16. The element according to claim 14, wherein said calibrated opening is provided in a thin wall of the same material as said first and second crowns, said thin wall having a thickness included between 10 and 80 μm.

17. The element according to claim 14, wherein at least one first lens may be aspheric type.

18. The element according to claim 14, wherein at least one second lens may be spheric type.

19. The element according to claim 16 further comprising an upstream chamber, located across from the measurement chamber relative to the thin wall.

20. A measurement system comprising an element according to claim 14, at least one optical emitter, and at least one optical receiver, mounted facing a second lens.

21. The system according to claim 20, further comprising means for bringing a fluid containing a sample to be characterized into the upstream chamber, where said fluid passes through the calibrated opening and opens into the measurement chamber.

22. The system according to claim 21, further comprising means for bringing a first sheath fluid near the upstream chamber.

23. The system according to claim 21, further comprising means for bringing a second sheath fluid near the measurement chamber.

24. The system according to claim 21, further comprising an interference filter facing at least one second lens, mounted on said element, radially between the first and second crowns.

25. The system according to claim 21, further comprising an achromatic doublet mounted on the element and arranged facing an optical emitter and a lens of the first crown.

26. The system according to claim 21, further comprising at least two electrodes, located axially on either side of the calibrated opening, and measurement means suited for measuring an impedance between said electrodes.
